(19) United States
(12) Patent Application Publication
(10) Pub. No.: US 2016/0132651 A1
(43) Pub. Date: May 12, 2016

(54) SYSTEMS AND METHODS FOR FACILITATING TRANSACTIONS BETWEEN HEALTHCARE CONSUMERS AND HEALTHCARE PROVIDERS

(71) Applicant: eLuminate Health, LLC, Leawood, KS (US)

(72) Inventors: Brian Killen, Lawrence, KS (US); Jason Matthew Roe, Overland Park, KS (US); Jeffrey S. Clary, Overland Park, KS (US); Peter Harrison Yates, Kansas City, MO (US); Rick E. Stricker, De Soto, KS (US); Tami Eileen Hutchison, Tempe, AZ (US)

(21) Appl. No.: 14/616,245

(22) Filed: Feb. 6, 2015

Related U.S. Application Data
(60) Provisional application No. 62/077,137, filed on Nov. 7, 2014.

(51) Int. Cl. G06F 19/00

(52) U.S. Cl. CPC G06F 19/328

(57) ABSTRACT

Systems and methods for facilitating healthcare transactions are described. The techniques describe herein may enable a user to select a rendering provider for a procedure.

### RELATED APPLICATION

This application is related to and claims priority from U.S. Patent Application No. 62/077,137, titled “SYSTEMS AND METHODS FOR FACILITATING TRANSACTIONS BETWEEN HEALTHCARE CONSUMERS AND HEALTHCARE PROVIDERS,” filed Nov. 7, 2014, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This disclosure relates to healthcare transactions, and more particularly to techniques for facilitating transactions between healthcare service consumers and healthcare service providers.

### BACKGROUND

Charges associated with healthcare services such medical procedures and the like may vary greatly based on provider and/or insurance coverage. Current techniques for providing healthcare service consumers with pricing information for a particular healthcare service procedure may be less than ideal.

### SUMMARY

In general, this disclosure describes techniques for facilitating transactions between healthcare service consumers (e.g., patients and the like) and healthcare service providers. In particular, this disclosure describes example techniques for providing healthcare service consumers with pricing information that enable these consumers to make informed decisions. It should be noted that although the examples described herein relate to providing information to healthcare service consumers, the techniques may be more generally applied to obtaining and processing information associated with healthcare transactions.

The details of one or more examples are set forth in the accompanying drawings and description below. Other features, objects, and advantages will be apparent from the description and drawings, and from the claims.

### BRIEF DESCRIPTION OF DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings is to scale unless specifically stated otherwise.

FIG. 1 is a block diagram illustrating an example system that may implement one or more techniques of this disclosure.

FIG. 2 is a block diagram illustrating an example of a computing device that may implement one or more techniques of this disclosure.

FIG. 3 is a conceptual diagram illustrating an example healthcare transaction facilitated using one or more techniques of this disclosure.

FIG. 4 is a conceptual diagram illustrating an example healthcare transaction facilitated using one or more techniques of this disclosure.

FIG. 5 is a conceptual diagram illustrating an example healthcare transaction facilitated using one or more techniques of this disclosure.

FIG. 6 is a conceptual diagram illustrating an example healthcare transaction facilitated using one or more techniques of this disclosure.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

EDI means Electronic Data Interchange and refers to a protocol used to transmit data from one computer network to another;

GUI means graphical user interface;

HIPAA means the U.S. federal Health Insurance Portability and Accountability Act of 1996;

“837” refers to an Electronic Data Interchange Health Care Claim record (generally corresponding to ANSI 837); and

“835” refers to an Electronic Data Interchange Health Care Claim payment/advice record (generally corresponding to ANSI 835, the American National Standards Institutes Health Care Claims Payment and Remittances Advice Format).

The term “healthcare service” refers to any product or service or procedure or the like relating in any way to healthcare. A particular healthcare service may be provided by one or more providers and may be provided in one or more locations. The system disclosed herein is not intended to be limited in any manner by the nature or kind of the product or service or procedure, by whom such healthcare service is provided, or by where such healthcare service is provided.

The terms “healthcare service provider” and “healthcare provider” and sometimes “provider” refer to any person or entity providing any aspect of a healthcare service. A particular healthcare provider may be or comprise one or more of: a hospital, a clinic, a surgery center, a lab, a physician, a nurse, a physician's assistant, a pharmacy, etc. It should further be appreciated that the system is not limited in any way by whether or not a healthcare provider actually provides a particular service to a particular healthcare consumer.

The terms “healthcare service consumer” and “healthcare consumer” and “consumer” refer to any person or entity that consumes or intends to consume any part of any healthcare service. A healthcare service consumer may sometimes be referred to herein as a patient, however it should be appreciated that the term “patient” is not intended to limit the scope in any or to imply any specific type of relationship between the healthcare service consumer and the healthcare service provider. It should further be appreciated that the system is not limited in any way by whether or not a healthcare consumer actually consumes a service. For example, a patient trying to find out the price of a particular medical procedure is referred to as a “consumer” regardless of whether or not that patient actually has or completes the particular procedure.

A “client healthcare claim” is one belonging to a health plan group participating in the healthcare marketplace.

The term “marketplace order” refers to a healthcare order for a covered healthcare procedure, made within the marketplace with a price set by a marketplace provider.

This disclosure describes example techniques for facilitating and supporting transactions between healthcare consumers (e.g., patients) and healthcare service providers (e.g., physicians, etc.). The techniques described herein may be implemented in devices configured to provide graphical user interfaces (GUIs) to a user. The graphical user interfaces may enable a user to engage in a healthcare transaction. For example, a patient may use a graphical user interface provided by a computing device to select a doctor to perform a particular healthcare procedure. Current systems for enabling a user to engage in a healthcare transaction may be less than ideal.

In the current United States healthcare marketplace, charges for the same medical procedure can vary greatly among providers, and for the same provider when dealing with different payers or types of payers. For some procedures, one provider's price can be several times greater than another's. Furthermore, regardless of provider, it may be difficult or impossible for a patient to find out what a procedure will cost beforehand. Existing healthcare transparency systems attempt to mitigate this situation by presenting estimated prices based on historical data. However, estimated prices may not be effective at predicting actual prices. As high-deductible, high coinsurance health plans become more common, this situation is becoming more critical for health plan members. A large difference in procedure price can greatly change the member's out of pocket cost. A higher charge amount may also mean higher payouts for the payer, whether a self-insured employer or a funded plan. The term “charge amount” refers to the amount a healthcare provider charges for a specific healthcare product or service. The systems and techniques described herein may mitigate the effects of highly variable and mostly opaque pricing in a healthcare marketplace. The systems and techniques described herein may bring market fairness to highly distorted existing system of prices.

In the current healthcare marketplace, medical providers send claims to payers for procedures provided in Electronic Data Interchange (EDI) Health Care Claim (837) records. A claim record generally includes all information needed by the payer to adjudicate the claim (sometimes other than the prices and payment rules). Each procedure claimed is identified by one or more procedure codes and each procedure claimed includes a charge amount. Payers may notify providers about claim adjudication via EDI Health Care Payment/Advice (835) records. A claim payment/advice record generally includes all information needed by the provider to match it to an original claim and to understand what was paid and why. In particular, the claim payment/advice record includes a payment amount, and adjustments to the original charge amount, if it differs from the payment amount. Healthcare consumer (e.g., patient) deductible, copay, and maximum out of pocket amounts can cause adjustments to the payment amount. Furthermore, contract prices set for provider networks can affect the payment amount.

Completion of some healthcare procedures requires multiple services, each provided by different healthcare providers. The parts of healthcare procedures can be independent, as, e.g., in the case of a surgery in which the surgical facility is one provider and the surgeon another. Further, one part of a healthcare procedure can be dependent on another, as, e.g., in the case of a surgical facility provider that contracts with an anesthesiologist. Further, some components of medical procedures have sub-components that are provided by providers that are not specifically known at the time a procedure is ordered. For example, a surgery facility might employ a group of anesthesiologists. Any one of those providers might provide anesthesia for a surgery on a given day. Another example might be the radiologist who reads a diagnostic image.

As described above, in the current healthcare environment, the health plan member may only have or be provided vague information about how much delivered health care will ultimately cost. As used herein, the term “member” with respect to a healthcare plan refers generally to a person or persons (e.g., a family) covered under the healthcare plan. Charge amounts are not typically disclosed at the time of a procedure, and even if they are, network contract and other contracts with payers can affect the allowed amount. The term “allowed amount” refers to a negotiated amount a payer will pay a healthcare provider for a specific healthcare service based on the contractual arrangements. The allowed amount is typically a discounted amount based on the Charge Amount, though is not always the case.

In some cases, multiple providers not necessarily known to the member file claims related to the procedure. Furthermore, unbeknownst to the member, different healthcare providers have widely varying final prices for many procedures. Thus, a member may not have enough information to make an informed choice, when that choice can have significant cost consequences. Further, when a member is choosing a rendering provider for a procedure, the member's choices may be constrained by distance from the member's residence. Finally, in the current health care market, the ordering provider often chooses the provider for a procedure, and may even schedule an appointment for the member. The ordering provider may have incentives to pick a rendering provider that would not be the choice of the member if the member had more and/or complete information.

In some aspects this disclosure describes system and techniques that enable providers to set prices dynamically and enable members/patients to choose providers for procedures with more and/or full transparency on those prices. That is, in one example, each provider can set a price for a procedure at any time, and as often as they wish. The example health care marketplace systems described herein may be supported by a claim system that enforces the prices (e.g., as negotiated between providers and payer/networks and/or listed on the marketplace), while minimizing changes to the existing claims processing flow. In one example, the process includes an ordering sub-process performed by the ordering physician that triggers the process, locking in the procedure prices, and notifying the member to choose the provider(s) for the member's ordered procedure. In one example when a member picks a provider to perform a procedure ordered for the member, the healthcare marketplace system locks in that provider's current price for the procedure. In one example, the locked in price is paid, even if the provider claims a different charge amount. After the procedure is performed, the provider may file a claim (837) as usual and may not need to keep track of historical price settings. The payer sees claims with a charge amount that matches the dynamic price that was locked in at the time of ordering the procedure. Thus, the system and techniques described herein may achieve dynamic price support without disrupting the normal processing of either the provider or the payer.

Further, in some aspects this disclosure describes systems and techniques for presenting a bundled price to the member/patient for a medical procedure with multiple parts supplied by multiple healthcare providers. In one example, systems and techniques described herein may enable the presentation of a bundled price to a member/patient for a procedure, regardless of how many healthcare providers will eventually submit claims for their parts of the procedure. In one example, the systems and techniques include the ability to present optional non-medical amenities available to the member, not covered by insurance.

In some aspects hereof, this disclosure describes techniques for allocating payment for a medical procedure comprised of services provided by more than one provider. The unnamed sub-providers may receive a part of the overall procedure price set by the main provider. In one example, the systems and techniques specify that the main provider of a procedure component that has a sub-component may designate some part of the component price as being for that sub-component. When the procedure is performed, whatever associated sub-provider actually provided that sub-component makes a claim for it, and is paid the indicated part of the component price.

In some aspects hereof, systems and techniques described herein allow a provider to set different prices for the same procedure component, depending on which other provider provides a corresponding procedure component in the same procedure. That is, in one example, a dynamic procedure component pricing for a provider may be extended by conditioning it on the providers of the other components of the procedure. For example, a provider may set a base price for a particular procedure component in a procedure that has more than one component. The provider may specify an override price for that procedure component that applies only when a particular provider or a particular set of providers provides another component of the procedure.

In some aspects hereof, systems and techniques described herein may include a mechanism for indicating what providers can provide what components of what procedures, and furthermore, what providers can cooperate by providing components of the same procedure. This mechanism may allow for creating and managing relationships among healthcare providers that provide specific components of medical procedures.

In some aspects hereof, systems and techniques described herein include a mechanism for setting provider price discounts conditioned on the member booking procedures that meet constraints reflecting excess inventory. In one example, the mechanism may allow providers to set price overrides conditioned on the health plan member booking procedure visits that meet constraints set by the provider, wherein the constraints reflect current inventory situations.

In some aspects hereof, systems and techniques described herein allow providers to set differential prices for procedure components based on demographic characteristics of the health plan member. In one example, a system may allow a provider to set override prices for any procedure component, based on demographic characteristics of the health plan member.

In some aspects hereof, systems and techniques enable a health plan member to choose provider(s) for a procedure after an ordering physician places an order. In this example, a system may introduce price transparency and price commitments to a health plan member at the earliest point in the process, i.e., once the need for a procedure has been identified. The exemplary system may provide information the member needs to make an informed choice and enable that choice.

In some aspects hereof, systems and techniques described herein enable alerts to be provided to a member. The alerts may alert a member when a provider with a lower price exists “close to” but outside a required distance. In one example, during the rendering provider choice process, the member is alerted to providers slightly outside the normal distance from residence constraint, but that have a lower price than providers inside the distance constraint.

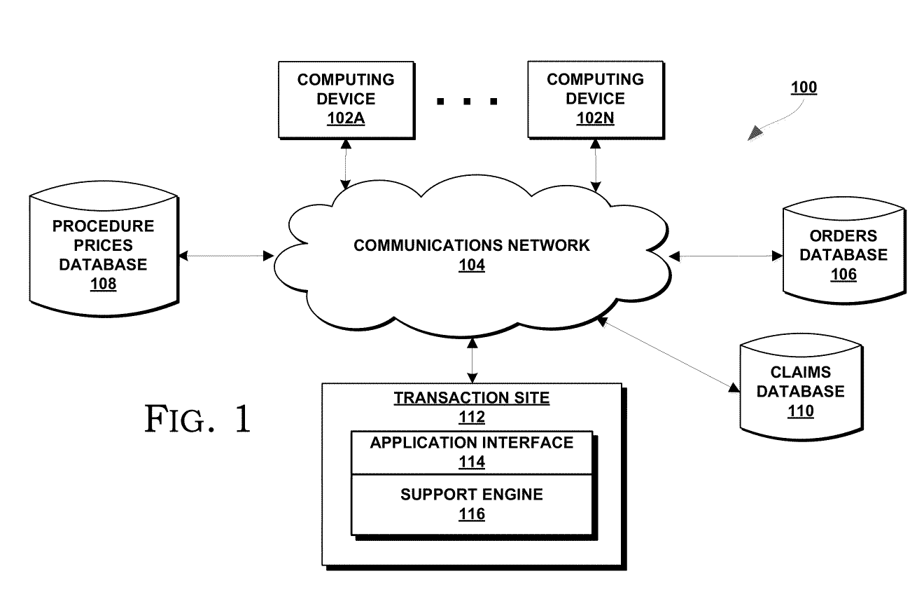

FIG. 1 is a block diagram illustrating an example system that may implement one or more techniques of this disclosure. System 100 may be configured to enable healthcare transactions in accordance with the techniques described herein. In the example illustrated in FIG. 1, system 100 includes one or more computing devices 102A-102N, communications network 104, orders database 106, procedure prices database 108, claims database 110, and transaction site 112. Transaction site 112 may include application interfaces 114 and support engine 116. System 100 may include software modules operating on one or more servers. Software modules may be stored in a memory and executed by a processor. Servers may include one or more processors and a plurality of internal and/or external memory devices. Examples of memory devices include file servers, network attached storage (NAS) devices, a local disk drive, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to enable users of computing devices 102A-102N to engage in healthcare transactions according to exemplary embodiments hereof. Computing devices 102A-102N may include any device configured to transmit data to and receive data from communication network 104. For example, computing devices 102A-102N may be equipped for wired and/or wireless communications and may include desktop or laptop computers, mobile devices, tablet computers, smartphones, cellular telephones, set-top boxes, personal gaming devices, or the like.

Communications network 104 may comprise any combination of wireless and/or wired communication media. Communication network 104 may include routers, switches, base stations, or any other equipment that may be used to facilitate communication between various devices and sites. Communication network 104 may form part of a packet-based network, such as a local area network, a wide-area network, or a global network such as the Internet. Communication network 104 may operate according to one or more communication protocols, such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, and/or an IEEE standard, such as, one or more of the 802.11 standards, as well as various combinations thereof.

As illustrated in FIG. 1, procedure prices database 106, orders database 108, and claims database 110 are connected to communications network 104. Each of procedure prices database 106, orders database 108, and claims database 110 may respectively include any and all combinations of the memory devices described above. Each of procedure prices database 106, orders database 108, and claims database 110 may store information associated with the operation of system 100.

Procedure prices database 106 may store data associated with pricing. For example, procedure prices database 106 may include a list procedures and a list of prices provided by one or more providers. Orders database 108 may store data associated with orders provided by one or more providers. For example, orders database 108 may include a list of pending orders and associated member and ordering provide information. Claims database 110 may store data associated with claims. For example, claims database 110 may include a list of pending claims and processed claims and associated member, ordering provider, rendering provider, and pricing information. Claims database 110 may store Electronic Data Interchange (EDI) Health Care Claim (837) records.

Transaction site 112 and/or computing devices 102A-102N may use information included in procedure prices database 106, orders database 108, and/or claims database 110 to facilitate healthcare transactions. Healthcare transactions may be facilitated by graphical user interfaces provided by transaction site and/or computing devices 102A-102N. In one example, graphical user interfaces presented by computing devices 102A-102N may include information included in procedure prices database 106, orders database 108, and/or claims database 110. Such information may be presented in a manner to facilitate healthcare transactions.

As illustrated in FIG. 1, transaction site 112 is connected to communications network 104. Transaction site 112 may be configured to provide data to computing devices 102A-102N. In one example, computing devices 102A-102N may process information provided by transaction site 112 in a manner that enables a user of a computing device to view information associated with a healthcare transaction. In one example, transaction site 112 includes a server. In the example illustrated in FIG. 1, transaction site 112 includes application interface 114 and support engine 116. Application interface 114 and support engine 116 may be implemented as any of a variety of suitable circuitry, such as one or more microprocessors, digital signal processors (DSPs), application specific integrated circuits (ASICs), field programmable gate arrays (FPGAs), discrete logic, software, software modules, hardware, firmware or any combinations thereof.

In one example, application interface 114, support engine 116, and modules thereof may be implemented using one or more programming languages. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, Python, UNIX Shell, Visual Basic or Visual Basic Script, Virtual Reality Markup Language (VRML), ColdFusion™ and other compilers, assemblers, and interpreters.

Application interface 114 may be configured to provide an interface between transaction site 112 and one or more of computing devices 102A-102N. For example, application interface 114 may provide one or more graphical user interfaces (GUIs) to computing devices 102A-102N. It should be noted that providing a graphical user interface to a computing device may include providing data to a computing device such that a computing device may generate a graphical user interface. Support engine 114 may be configured to support the operations of transaction site 110.

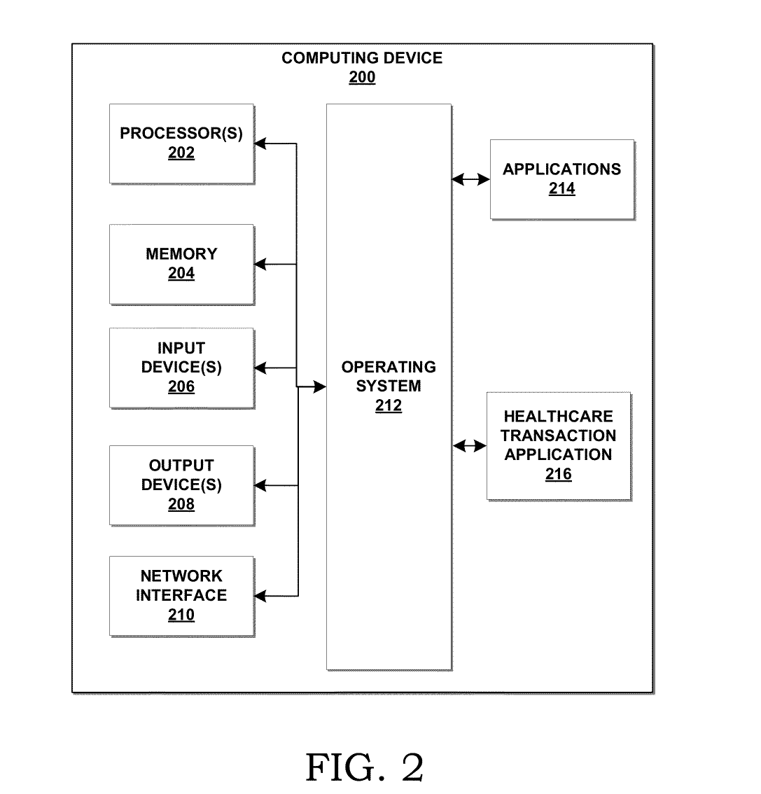

FIG. 2 is a block diagram illustrating an example of a computing device that may implement one or more techniques of this disclosure. Computing device 200 is an example of a computing device that may execute one or more applications, including healthcare transaction application 216. Computing device 200 may include or be part of a portable computing device (e.g., a mobile phone, netbook, laptop, personal data assistant (PDA), or tablet device) or a stationary computer (e.g., a desktop computer, or set-top box). Computing device 200 includes processor(s) 202, memory 204, input device(s) 206, output device(s) 208, and network interface 210.

Each of processor(s) 202, memory 204, input device(s) 206, output device(s) 208, and network interface 210 may be interconnected (physically, communicatively, and/or operatively) for inter-component communications. Operating system 212, applications 214, and healthcare transaction application 216 may be executable by computing device 200. It should be noted that although example computing device 200 is illustrated as having distinct functional blocks, such illustration is for descriptive purposes and does not limit computing device 200 to any particular hardware architecture. Functions of computing device 200 may be realized using any combination of hardware, firmware, and/or software implementations.

Processor(s) 202 may be configured to implement functionality and/or process instructions for execution in computing device 200. Processor(s) 202 may be capable of retrieving and processing instructions, code, and/or data structures for implementing one or more of the techniques described herein. Instructions may be stored on a computer readable medium, such as memory 204. Processor(s) 202 may be digital signal processors (DSPs), general purpose microprocessors, application specific integrated circuits (ASICs), field programmable logic arrays (FPGAs), or other equivalent integrated or discrete logic circuitry.

Memory 204 may be configured to store information that may be used by computing device 200 during operation. As described above, memory 204 may be used to store program instructions for execution by processor(s) 202 and may be used by software or applications running on computing device 200 to temporarily store information during program execution. For example, memory 204 may store instructions associated with operating system 212, applications 214, and healthcare transaction application 216 or components thereof, and/or memory 204 may store information associated with the execution of operating system 212, applications 214, and healthcare transaction application 216.

Memory 204 may be described as a non-transitory or tangible computer-readable storage medium. In some examples, memory 204 may provide temporary memory and/or long-term storage. In some examples, memory 204 or portions thereof may be described as volatile memory, i.e., in some cases, memory 204 may not maintain stored contents when computing device 200 is powered down. Examples of volatile memories include random access memories (RAM), dynamic random access memories (DRAM), and static random access memories (SRAM). In some examples, memory 204 or portions thereof may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Input device(s) 206 may be configured to receive input from a user operating computing device 200. Input from a user may be generated as part of a user running one or more software applications, such as healthcare transaction application 216. Input device(s) 206 may include a touch-sensitive screen, track pad, track point, mouse, a keyboard, a microphone, video camera, or any other type of device configured to receive input from a user.

Output device(s) 208 may be configured to provide output to a user operating computing device 200. Output may tactile, audio, or visual output generated as part of a user running one or more software applications, such as applications 214 and/or healthcare transaction application 216. Output device(s) 210 may include a touch-sensitive screen, sound card, a video graphics adapter card, or any other type of device for converting a signal into an appropriate form understandable to humans or machines. Additional examples of an output device(s) 210 may include a speaker, a cathode ray tube (CRT) monitor, a liquid crystal display (LCD), or any other type of device that can provide output to a user.

Network interface 210 may be configured to enable computing device 200 to communicate with external devices via one or more networks. Network interface 210 may be a network interface card, such as an Ethernet card, an optical transceiver, a radio frequency transceiver, or any other type of device that can send and receive information. Network interface 210 may be configured to operate according to one or more communication protocols.

Operating system 212 may be configured facilitate the interaction of applications, such as applications 214 and healthcare transaction application 216, with processor(s) 202, memory 204, input device(s) 206, output device(s) 208, network interface 210 and other hardware components of computing device 200. Operating system 212 may be an operating system designed to be installed on laptops and desktops. For example, operating system 212 may be a Windows operating system, Linux, or Mac OS. In another example, if computing device 200 is a mobile device, such as a smartphone or a tablet, operating system 212 may be one of Android, iOS, or a Windows mobile operating system.

Applications 214 may be any applications implemented within or executed by computing device 200 and may be implemented or contained within, operable by, executed by, and/or be operatively/communicatively coupled to components of computing device 200, e.g., processor(s) 202, memory 204, and network interface 210. Applications 214 may include instructions that may cause processor(s) 202 of computing device 200 to perform particular functions. Applications 214 may include algorithms that are expressed in computer programming statements.

Healthcare transaction application 216 may be an application that allows computing device 200 to perform functionality associated with system 100. In one example, healthcare transaction application 216 may include or operate on a web browser, such as, for example, Internet Explorer of Google Chrome and any associated supporting software modules (e.g., plugins). In one example, healthcare transaction application 216 may be a standalone application. It should be noted that techniques described herein may be performed by healthcare transaction application 216 and/or transaction site 112. It should be noted that the techniques described herein are not limited to a particular system architecture and may be realized using any combination of hardware, firmware, and/or software implementations.

As described above, existing healthcare transparency systems may be less than ideal. In one example, system 100 may be configured to facilitate the management of one or more of the following components of a healthcare transaction (1) provider price management, (2) ordering, (3) provider selection, and (4) claim processing.

In one example, provider price management as enabled by system 100 may allow rendering providers to set dynamic prices for the procedures it performs. In one example, the prices can be changed at any time, but the price at the time of an order is locked in. In one example, ordering as enabled by system 100 may allow an ordering provider (e.g., a physician) to trigger a process by ordering a procedure for a consumer (e.g., a patient). In one example, provider selection as enabled by the system may allow a patient to select a provider (or providers, if the procedure has multiple component) to perform the procedure. The consumer may be able to make a choice with complete price transparency, getting a commitment both for total charge and out of pocket cost. It should be appreciated that the out of pocket value is accurate but represents the current state of deductibles for that member. The out of pocket value may change, e.g., if more claims come in before this claim is finalized and fully processed. In one example, claim processing as enabled by system 100 may alter the existing claim flow in a current healthcare marketplace enough to enforce the patient's choice of providers, and the price set at order time. That is, claim processing as enabled by system 100 may provide enough information for the provider's and payer's existing claim handling systems to work as usual. It should be noted that the techniques described herein may be used within a health insurance plan, and may be applied to any fraction of the procedures covered by the plan.

The efficiency of a healthcare marketplace depends on having up to date prices for procedure components to be performed by providers. System 100 allows each provider to manage its full set of prices, setting each price as often as desired. Special override prices can be defined which apply when their specific conditions are met. It is expected that providers will set competitive prices for procedures to avoid being priced out of the market.

Ordering and enabled by system 100 may be a modification of the existing practice of an ordering physician. However, instead of the typical procedure of sending an order for a procedure (e.g., a CAT scan) to a single selected rendering provider, the ordering physician may create the order in the system 100 (e.g., using one or computing device 102A-102N), to enable a member to select one of a plurality of rendering provider. In practice, implementing this ordering process may involve a plan change, as currently in many plans some routine procedures can be ordered and completed with no prior authorization from the plan.

In one example, completion of the ordering step by an ordering physician may result in a notification to the plan member to tell the member to select a rendering provider. That is, an order may be stored in order database 106 and transaction site 112 may provide a message to a user based on an update to order database 106. During provider selection, the member/patient may view all available providers that can perform the ordered procedure. For example, transaction site 112 may retrieve order data from order database 106, retrieve corresponding provider price information from procedure prices database 106, and provide a graphical user interface to a computing device of a member. The graphical user interface may enable the user to see procedure prices, as well as any other available information about the providers, such as location, quality, and customer satisfaction ratings. Based on this information a user may be enabled to make an informed choice when selecting a rendering provider. It should be noted that system 100 may be integrated with a payer system. Information provided by a payer system may enable a member to see actual out of pocket costs, taking remaining deductible, copay, and coinsurance into account. Further, claim processing as enabled by system 100 may support the techniques described herein by enforcing the agreed upon procedure price and provider selection made by the member.

In one example, before processing a claim (e.g., 837 EDI record) for a procedure using system 100, a claim administrator may route the claim to a component (e.g., transaction site 112) that edits the claim in case the claim charge amount is different from the agreed upon price, and even may reject the claim if the rendering provider is not the same as the provider chosen by the member. Then, the claim may be adjudicated by the payer's claim administrator, except that the administrator pays the claim “as charged,” since the charge amount is guaranteed to be the agreed upon price. In one example, after the claim has been adjudicated, instead of sending the claim payment/advice (835 EDI record) to the rendering provider, the payer's administrator routes it to a component (e.g., transaction site 112) that may edit the claim payment record to “back out” any changes in the original charge amount, and create matching adjustments. This allows the rendering provider to balance the original claim charge amount and accept the adjusted amount that reflects the dynamic price that was in effect at the time of the order.

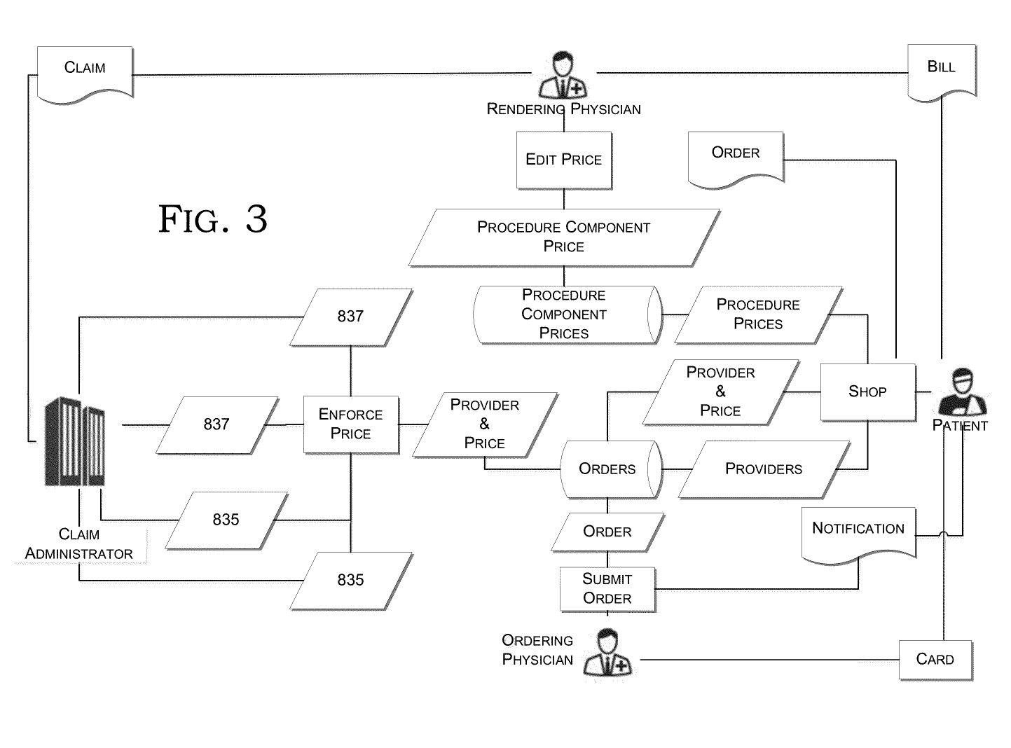

FIG. 3 illustrates processing of a typical claim using system 100. Each of rendering physician, patient, ordering physician, and claim administrator illustrated in FIG. 3 may be operating one of computing device 102A-102N. As illustrated in FIG. 3, a rendering physician may edit a price for a procedure. The rendering physician may edit the price using a graphical user interface. Procedure price components may be stored in procedures prices database 108. As illustrated in FIG. 3, an ordering physician may submit an order. The ordering physician may submit the order using a graphical user interface. Order information may be stored in orders database 106. As illustrated in FIG. 3, a patient may shop for a rendering provider for an ordered procedure. A patient may shop using a graphical user interface. As illustrated in FIG. 3, claims administrator may receive claim information from a rendering physician and may receive (837) and (835) information. Claims may be processed as described above.

System 100 may provide several ways for a rendering physician to edit price. The inventory of a healthcare provider may be defined as the collection of available bookings for procedures. Some booking slots for a provider might be less likely to be used than others. In one example, system 100 may enable a provider to set procedure pricing base on inventory. In one example, the provider can set constraints that identify particular booking slots, and offer a reduced price for members willing to book in those slots. For example, an imaging center might typically have fewer appointments for MRIs after 3:00 PM on Friday. If the regular price for a head MRI is $1,400, the imaging center provider may set a discount price of $1,000 if the member agrees to book after 3:00 PM on a Friday. In one example, the provider may set recurring discounts based on time-of-day, day-of-week, and/or day-of-month. Further, the provider may also set one-time discounts for particular time periods. System 100 may enable a provider to remove or disable price discounts at any time. In one example, price discounts already chosen by members remain in force. In one example, when a member chooses a provider for an ordered procedure, the member is given the option to pick a discounted price that comes along with scheduling constraints. The member may lock in that price when the member chooses a provider. It should be noted that the price discount mechanism may impose certain obligations on the provider so that implementation does not require synchronizing inventory availability between system 100 and independent provider systems. In one example, if a member chooses a discounted price for a procedure, but the provider has run out of scheduling slots that meet the discount constraints, then the provider must still honor the discounted price even if the booking does not meet the constraints. On the other hand, the member is obligated to accept a booking time that meets the discount constraints if one is available. If the member changes wishes to choose another time-slot, then the member must re-choose the procedure without the discount.

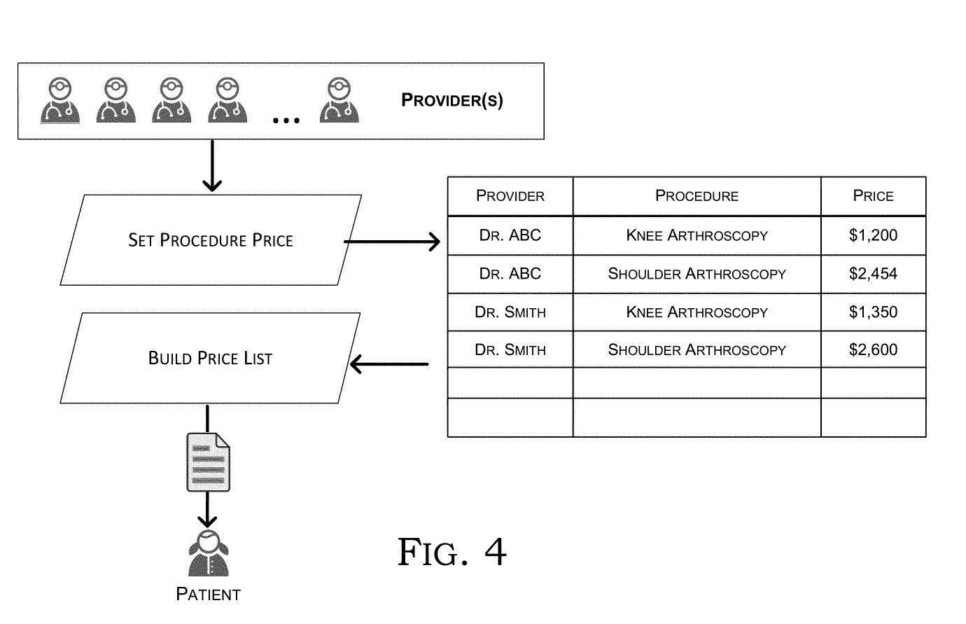

Typically, a provider may have a set of regular prices for the procedure components it can perform. In one example, system 100 may enable a provider to specify overrides for those prices based on health plan member demographic characteristics. When the health plan member views prices for an ordered procedure (e.g., using a graphical user interface, such as graphical user interface illustrated in FIG. 4), the member may see the price as discounted for any override price that applies to the member's demographic. In one example, system 100 enables a provider to set multiple price overrides for the same procedure component, where each override is based on a different demographic characteristic. The effective price for a given health plan member may be the lowest one based on a demographic characteristic that applies to him.

In some cases, a health insurance plan may require preauthorization for a performed procedure to be reimbursed. In one example, system 100 may provide different provider selection processes based on whether preauthorization is required. In one example, where a procedure does not require preauthorization an ordering physician may use system 100 for ordering the procedure and the process of member engagement may be trigger. In the case, where a procedure requires preauthorization. A preauthorization authority, other than, the ordering physician may trigger the process of member engagement.

In either case, once an order is triggered, the member may be notified of the procedure and of the need to pick a rendering provider. That notification can be in person at the time the procedure is ordered, by email, by phone, etc. The member may be presented with a list of options for rendering providers for the procedure. If the procedure consists of a single procedure component, then each list item mentions only one provider. If the procedure consists of multiple (typically two) components, then each list item shows an allowed combination of providers to perform the procedure (e.g., a facility provider and professional provider), as described above.

Exact price information for providers that participate in the system may be shown to a user and the list item constitutes a commitment to perform the procedure for that price using a graphical user interface as described above. Other information on providers, such as quality and customer satisfaction, may be shown as available. For providers that are not part of the network or have not provided information, an estimated price may be shown. For each potential choice, a member may be shown the price commitment, as well as out of pocket cost, which considers remaining deductible, copayment, coinsurance, etc. Finally, the member may choose one of the available rendering providers (or providers in the case of a procedure with multiple components). His choice authorizes the provider to perform the procedure and expect a claim to be paid.

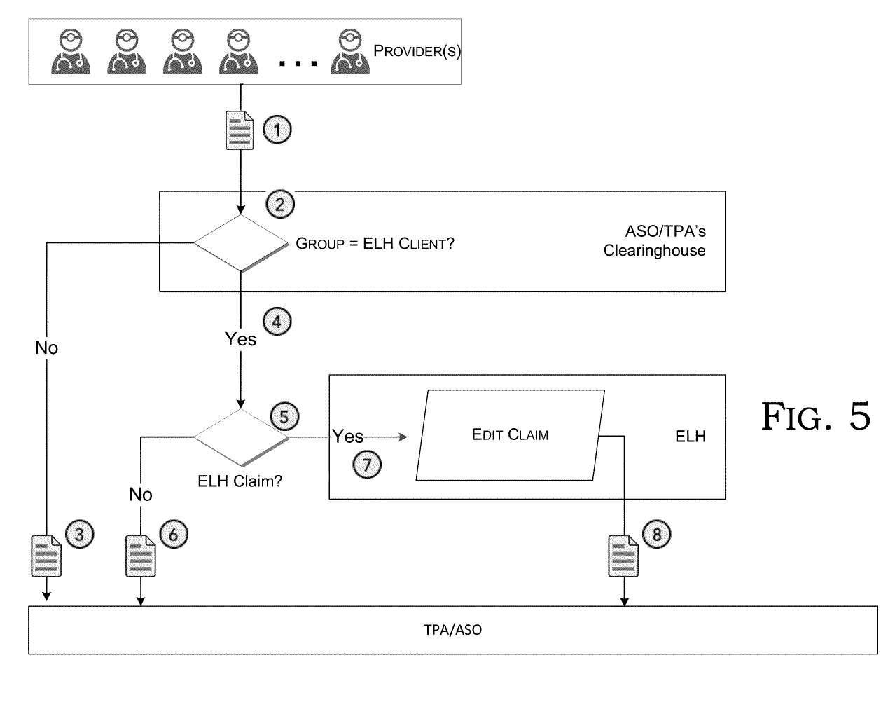

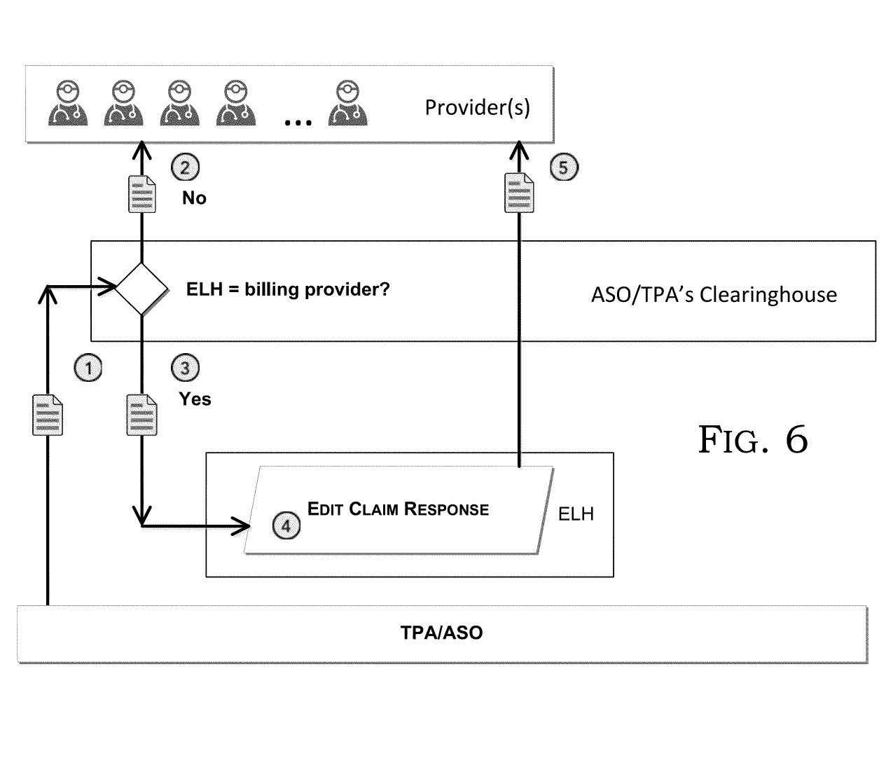

As described above, system 100 may support dynamic procedure pricing. FIGS. 4-6 illustrate how system 100 may support dynamic procedure pricing. That is, FIGS. 5 and 6 illustrate how a claim (837) for a single procedure may flow from a provider to the payer, may be adjudicated, and may result in a claim payment/advice (835) that flows from the payer back to the provider. In practice, an order may be comprised of several claim lines that can be contained in one or more claim records, and result in one or more claim payment/advice records. An order can also include components from more than one provider (e.g., facility and professional). Each provider may submit claims, and the order price may be apportioned across the claims from all providers. Furthermore, claims and claim payments may pass through multiple clearinghouses as they travel between provider and payer. It should be noted that in other examples, details of the example flow may differ from this description and from the illustrated FIGS. 4-6.

As illustrated in FIG. 4, providers may set procedure prices and a patient may access a list of prices (e.g., using computing device 200). As illustrated in FIG. 4, a list including a respective provider, procedure, and price may be generated and presented to a user (e.g., in the form of a graphical user interface generated by a computing device).

With reference to FIG. 5, an example claim flow using system 100 is described. In the example illustrated in FIG. 5, first, a provider submits a claim record (837) to the payer's clearinghouse (at 1). The clearinghouse determines whether the member's healthcare plan is included as a client utilizing the techniques described herein (at 2). The clearinghouse routes only those claims based on whether the member's health plan group is a client. In one example, a client may be referred to as an ELH client and corresponding claims may be referred to as ELH claims. Claims of non-ELH clients are forwarded to the payer (at 3). Claims of ELH clients are forwarded to the ELH system (at 4). The ELH system, which may include one or more components of system 100, determines whether a claim is an ELH claim (at 5). In the example illustrated in FIG. 5, if the claim is for a procedure not handled as an ELH claim, then the ELH system forwards the claim to the payer and the claim flow is complete (at 6). Otherwise, the ELH system may edit the claim as follows: the charge amount may be edited to match the provider's price at the time of order; the billing provider may be changed to ELH to signal to the payer to “pay as charged;” the patient control number may be edited to guarantee uniqueness (at 7). The ELH system then forwards the edited claim to the payer (at 8).

With reference to FIG. 6, an example claim flow using system 100 is described. In the example illustrated in FIG. 6, a claim payment/advice (835) flow is described. A claim may be adjudicated by a payer (1). After claims are adjudicated, claims are forwarded to a provider (2) or the payer's clearinghouse routes only those claim payments to the ELH system in which the member's health plan group is an ELH client (3). The ELH system matches the claim payment to the original claim, using the unique patient control number from the claim. The ELH system may edit the claim payment as follows: the charge edit may be reversed, so the provider sees the charge amount he sent in the original claim; an adjustment may be added to reconcile that original charge amount with the provider's price at the time of ordering; the billing provider may be restored to be the original provider; the patient control number may be restored to the original sent by the provider (4). The ELH system forwards the edited claim payment to the provider (5).

As described above, system 100 may enable a bundled price to be presented to a consumer for a medical procedure with multiple parts supplied by multiple healthcare providers. In one example, a set of composite medical procedures, each of which is comprised of one or more parts or components may be defined. Each component may be a service provided by a single healthcare provider (with the exception of subcomponents as described below). A healthcare provider may be a healthcare provider (e.g., a physician) or a facility (e.g., a hospital, surgery center, or lab).

Each healthcare provider may use system 100 to maintain a dynamic price for each procedure component it provides. The provider may change the dynamic price at any time, but whenever an order is made, the price for that order is locked in to the provider price at that time. Some procedure components may contain subcomponents provided by an associate provider of the main provider of the component. The main component provider may set the price of a subcomponent to any fraction of the component price. The subcomponent price may determine how a claim from the subcomponent provider will later be paid, but otherwise may have no effect on how the procedure price is presented to the member.

Further, a set of relationships among providers specifying what procedures they can do together may be assumed. For example, a knee arthroscopy procedure might have a facility component and a professional i.e. surgeon component. Suppose Acme Hospital and Dr. Smith have a relationship that specifies that for knee arthroscopy Acme Hospital can supply the facility component and Dr. Smith can supply the surgical component. Then the combination of Acme Hospital and Dr. Smith is eligible for presentation to the member. Transaction site 112 may include a set of rules to determine which combinations are eligible for presentation to a user.

When a procedure is ordered for a member, the system 100 provides for presenting a member with a list of provider combinations, each of which could perform the procedure. For each combination, the member sees a single bundled price, which is the sum of the component prices of all the main providers providing the components. The member can also see information about each of the providers. For example, using a graphical user interface similar to the example graphical user interface illustrated in FIG. 4. Thus, for the knee arthroscopy example above, the member would see a line for Acme Hospital/Dr. Smith showing the combined price for each of the two providers. The member could also see a line for each other allowed provider combinations for that procedure.

In one example, providers and prices for subcomponents may not be shown to a member. This may make the selection process more efficient for a member. In the knee arthroscopy example, if there were an anesthesiology subcomponent, it would be included in the facility price and the associate provider would not be mentioned. It is possible that the particular associate provider providing the subcomponent is not known until the time of healthcare delivery. The member chooses a bundled price (line) for the procedure, and thereby locks in that price. Each cooperating provider is obligated to accept the price it had set at that time for its procedure component. System 100 may also include the ability to display additional non-medical services and associated pricing, offered by certain providers. Examples might include private room, 5-star food, etc. These additional amenities may be clearly marked as not covered by insurance, and may be illustrated as in addition to and independent of the dynamic provider prices set for procedure components.

As described above, a set of defined medical procedures may be comprised of components. In one example, a main medical provider may be responsible for each procedure component. In practice, some components have sub-components (e.g., anesthesiology), which while the general responsibility of the main provider, are actually provided by an associate provider of the main provider.

In one example, system 100 may enable providers to indicate what procedure components they perform (possibly with cooperating main providers, e.g., in a facility/professional situation). Providers may set their dynamic prices for procedure components at any time. Further, for any procedure components with subcomponents, system 100 may enable a provider to designate some part of the dynamic component price as allocated to a subcomponent. Whenever that procedure is performed, the designated subcomponent amount is paid to the sub-provider that provided the subcomponent. In one example, the amount paid to the sub-provider may be specified as a fraction, a percentage, or as an absolute amount.

In one example, system 100 may enable a provider to set different dynamic prices for a procedure component based on other providers involved in the procedure. To illustrate, consider the following example scenario: A surgical procedure has two components, a facility component and a professional component; Dr. Smith provides the professional component, with a price set at $800; Acme Hospital provides the facility component, with a price set at $1,300; Reliable Surgery Center provides the facility component, with a price set at $1,200; Dr. Smith prefers to work at Acme Hospital, so he sets an override to his normal price, specifying a price of $600 when the procedure is done at Acme Hospital.

When the surgical procedure is ordered for a health plan member, and the member views available provider choices for the procedure, among them will be the following two choices: (1) Dr. Smith/Acme Hospital. Price: $1,900; and (2) Dr. Smith/Reliable Surgery Center. Price: $2,000.

It should be noted that assuming Dr. Smith as the surgeon performing the procedure, the member's total price is lower for having the procedure done at Acme Hospital than at Reliable Surgery Center. This reflects Dr. Smith's differential price based on the cooperating provider. It should be noted that system 100 may enable a provider to set the override price either lower or higher than the standard price.

In one example, system 100 may enable relationships among healthcare providers that provide specific components of medical procedures to be created and/or managed. Provider relationships enabled by system 100 may be described by considering providers one-by-one and procedures one-by-one. Each provider may be defined (e.g., in procedure prices database 108) to be able to provide a subset of all the components of medical procedures in the system. Typically, a provider will only be able to provide a single component of any one procedure. The allowed components for all providers with no other information could be seen to imply a set of provider groupings allowed to cooperate to supply each procedure. However, not all providers may be able to cooperate on procedures. For example, physicians must have procedure-specific “privileges” at a hospital to perform procedures there.

System 100 may be configured to represent these real-world relationship as a set of 4-tuples with the following values: (1) Originating provider; (2) Originating procedure component; (3) Cooperating provider; (4) Cooperating procedure component. One such 4-tuple indicates an assertion by the originating provider that it is able and willing to cooperate with the cooperating provider on the specified procedure. In one example, the relationship is only complete and operable when the cooperating provider makes the complementary statement with respect to the first provider. Thus, for example, a surgeon Dr. Smith might claim to be able to perform knee arthroscopy at Acme Hospital. At that point, the relationship is incomplete, and no member will be given a choice of Dr. Smith/Acme Hospital for knee arthroscopy. Only when Acme Hospital makes the complementary claim that it can provide the facility component for knee arthroscopy and is willing to work with Dr. Smith will the relationship be established. Typically, procedures will have only one or two procedure components. However, this system 100 may generalizes to N procedure components in a procedure. In that case, each provider must provide a 4-tuple for each proposed cooperating provider for all N−1 other procedure components. In one example, the relationship is only complete when a set of N providers has all indicated to work with each other on a procedure.

In a typically scenario, a health plan member, who has had a procedure ordered, chooses a rendering provider from a list of providers within a geographical area. The member's possible choices may be constrained by a maximum distance from the member's residence. If a provider is only slightly outside the maximum distance, but has a lower price than providers inside the maximum distance, the member might want to consider traveling further to save money. In one example, system 100 may be configured to alert members to such opportunities during the rendering provider choice process. In one example, when a member is making a rendering provider choice through a graphical user interface (e.g., a web interface), the member may see a “better price” button or another UI element to enable the member to relax the distance requirement and choose the less expensive provider. The criteria for triggering the better price mechanism depend on the extra distance to be traveled and the amount of money that can be saved. In this manner, system 100 may be configured to facilitate healthcare transactions.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media that is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. In addition, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general-purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. In addition, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method of facilitate a healthcare transaction, the method comprising:
providing a graphical user interface enabling a provider to set pricing information for a healthcare procedure;
for an ordered healthcare procedure, generating a list including providers and respective pricing information; and
providing a graphical user interface enabling a patient to select a provider from the list.

2. The method of claim 1, wherein the graphical user interface enabling a provider to set pricing information for a healthcare procedure enables a provider to set price overrides.

3. The method of claim 1, wherein a price override is based on one or more of: other provider pricing information, patient demographic information, inventory levels, time of the healthcare procedure, date of the healthcare procedure, location of the procedure, and healthcare procedure component information.

4. The method of claim 1, wherein the graphical user interface enabling a patient to select a provider includes an element enabling patient to expand the list by relaxing filter criteria

5. The method of claim 4, wherein the relaxed filtering criteria comprises a distance from the patient's location.

6. A method for processing a healthcare claim, the method comprising:
receiving a healthcare claim;
for non-client healthcare claim, forwarding the claim unchanged to a payer;
for client healthcare claim not matching a market place order, forwarding the healthcare claim unchanged to a payer;
for client healthcare claim matching a market place order, editing one or more of: a claim charge amount to match a locked in dynamic price from the order, a billing provider to a client, and a patient control number to be unique, and forwarding the claim to the payer;
receiving a claim payment matching a previously processed healthcare claim;
reversing any edits and adding reconciling adjustments; and
forwarding the claim payment to the original provider.

7. The method of claim 6, wherein a payer's clearinghouse forwards only healthcare claims for client health plan groups to the marketplace.

8. The method of claim 6, wherein the payer's clearinghouse forwards all healthcare claims to the marketplace, and the client filters out claims which are for the client's health plan groups.

9. The method of claim 6, wherein a provider sends healthcare claims directly to a payer's clearinghouse.

10. The method of claim 6, wherein a provider sends healthcare claims via one or more intermediate clearinghouses.

11. The method of claim 6, wherein the price for one order is apportioned across healthcare claims from two or more providers.

12. A system for a facilitating a healthcare marketplace with dynamic and transparent pricing, the system comprising:
provider price management component;
ordering component;
provider selection component; and
claim processing component.

13. The system of claim 12, wherein an interface to any or all of the first three subparts includes a web interface or a computer program connected to a network.

14. The system of claim 12, wherein the claim processing component works using standard HIPAA EDI claim re-pricing record segments, instead of editing the charge amount.

15. The system of claim 12, wherein the member chooses a provider/price by talking to an authorized user of the system, such as an ordering provider or customer service representative.

16. The system of claim 12, wherein some procedures consist of more than one procedure component, each separately priced and provided by a different rendering provider.

17. The system of claim 12, wherein the claim processing subpart depends on exchanging HIPAA EDI records (837s and 835s) with plan administrators or their agents, via file transfer, web service, or any other electronic means.
